(19) United States
(12) Patent Application Publication
(10) Pub. No.: US 2012/0033260 A1
(43) Pub. Date: Feb. 9, 2012

(54) INFORMATION PROCESSING APPARATUS, CONTROL METHOD FOR INFORMATION PROCESSING APPARATUS, AND STORAGE MEDIUM

(75) Inventor: Koji Inose, Saitama-shi (JP)

(73) Assignee: CANON KABUSHIKI KAISHA, Tokyo (JP)

(21) Appl. No.: 13/204,435

(22) Filed: Aug. 5, 2011

(30) Foreign Application Priority Data
Aug. 9, 2010 (JP) 2010-178305

(51) Int. Cl. G06F 3/12

(52) U.S. Cl. 358/1.15

(57) ABSTRACT

An information processing apparatus configured to display a screen using information acquired from a server apparatus includes a recording unit configured to record acquisition destination information for acquiring the information from the server apparatus, a receiving unit configured to receive, from the sever apparatus, a logoff notification indicating that a user has logged off the server apparatus, and a deletion unit configured to delete the recorded acquisition destination information in response to the receiving unit receiving the logoff notification.

### BACKGROUND OF THE INVENTION

1. Field of the Invention

The present invention relates to an information processing apparatus for acquiring screen information from a server apparatus and displaying a screen, a control method for the information processing apparatus, and a storage medium.

2. Description of the Related Art

A recent information processing apparatus, such as a personal computer (PC), can connect to a web server on a network and display screen information provided by the web server on a web browser included in the information processing apparatus.

In this case, the information processing apparatus designates a Uniform Resource Locator (URL) via the web browser and performs an acquisition request of an operation screen to the web server. The web server generates Hyper Text Markup Language (HTML) data for causing the browser to provide a display in response to the acquisition request from the information processing apparatus by a web application and transmits the HTML data to the information processing apparatus. The information processing apparatus analyzes the received HTML data by the web browser and displays a screen based on a description of the received HTML data.

Further, when the information processing apparatus receives an input of information by a user to the screen displayed on the web browser, the information processing apparatus can notify the input information to the web browser. Then, the web server, which has received the information, executes processing according to the input information by the web application, and transmits again HTML data to the information processing apparatus.

Since a URL input by a user to the web browser is recorded, the user can connect again to the URL by selecting the URL or pushing a button provided on the web browser in association with the URL.

However, when the information processing apparatus unconditionally records a URL, some problems may occur in operability or security. Particularly, on a browser provided in an information processing apparatus represented by a multifunction peripheral (MFP), which is assumed to be used by unspecified users, there maybe a problem that a user can connect the URL used by other persons.

Japanese Patent Application Laid-Open No. 2005-153346 discusses a technique of improving operability and security by recording a URL while associating the URL with information identifying a user operating a browser. Further, Japanese Patent Application Laid-Open No. 2006-134261 also discusses a technique of improving operability and security of an information processing apparatus by recording a URL only while a browser is displayed on an operation screen of the information processing apparatus, and deleting the URL when the browser ends or is switched with another screen.

In these information processing apparatuses having such configurations, there are many opportunities in which unspecified users operate a browser started and displayed in an information processing apparatus to use a web application.

On the other hand, a web application prepared in a web server becomes usable in response to a login instruction to the web server by a user, and becomes unusable in response to a logoff instruction. In a URL used by a browser which is constantly displayed and used regardless of login and logoff, it is essentially desirable for the URL to be held only while a specified user continues login to the web server, in view of operability and security.

Under such situation, since the technique discussed in Japanese Patent Application Laid-Open No. 2005-153346 cannot identify a user operating a browser, arbitrary URLs specified by unspecified users are recorded in an information processing apparatus, so that operability and security cannot be protected.

Similarly, in the technique discussed in Japanese Patent Application Laid-Open No. 2006-134261, arbitrary URLs specified by unspecified users are recorded with respect to a browser constantly displayed, so that a problem in which operability and security cannot be protected remains.

### SUMMARY OF THE INVENTION

The present invention is directed to a method capable of suitably deleting acquisition destination information needed to acquire information used in screen display from a server apparatus.

According to an aspect of the present invention, an information processing apparatus for displaying a screen using information acquired from a server apparatus includes a recording unit, a receiving unit, and a deletion unit. The recording unit is configured to record acquisition destination information for acquiring the information from the server apparatus. The receiving unit is configured to receive, from the sever apparatus, a logoff notification indicating that a user has logged off the server apparatus. The deletion unit is configured to delete the recorded acquisition destination information in response to the receiving unit receiving the logoff notification.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an entire configuration of a system including an information processing apparatus according to a first exemplary embodiment of the present invention.

FIG. 2 is a block diagram illustrating a configuration of an MFP illustrated in FIG. 1.

FIG. 3 illustrates an outer appearance configuration of an operation unit illustrated in FIG. 2.

FIG. 4 is a block diagram illustrating a configuration of a web server illustrated in FIG. 1.

FIG. 5 illustrates a software configuration of the information processing system.

FIG. 6 is a flowchart illustrating an example of a control procedure by the information processing apparatus according to the first exemplary embodiment.

FIGS. 7A to 7D illustrate an example of a table managed by an analysis unit illustrated in FIG. 5.

FIG. 8 illustrates an example of control information acquired from the web server.

FIG. 9 is a flowchart illustrating an example of a data processing procedure by a server apparatus according to the first exemplary embodiment.

FIG. 10 is a flowchart illustrating an example of a control procedure by an information processing apparatus according to a second exemplary embodiment of the present invention.

FIGS. 11A and 11B illustrate an example of a table held by an application management unit.

FIG. 12 is a flowchart illustrating an example of a data processing procedure by the server apparatus according to the second exemplary embodiment.

### DESCRIPTION OF THE EMBODIMENTS

Various exemplary embodiments, features, and aspects of the invention will be described in detail below with reference to the drawings.

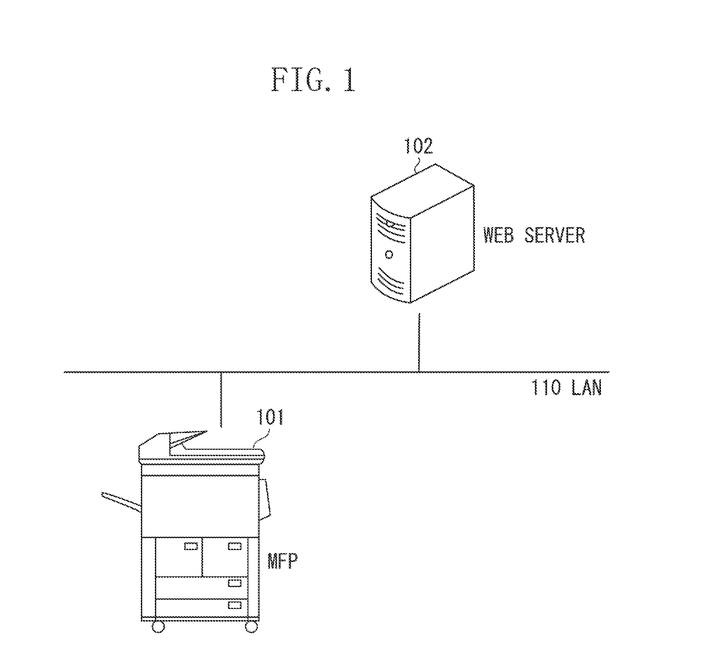

FIG. 1 illustrates an entire configuration of a system including an information processing apparatus according to a first exemplary embodiment of the present invention. An MFP 101 and a web server 102 are connected to a local area network (LAN) 110 so as to communicate with each other. In addition, in the present exemplary embodiment, although the MFP 101 is used as an example of an information processing apparatus, the information processing apparatus is not limited to the MFP 101 if the information processing apparatus can acquire screen information from a web server. Further, in the present exemplary embodiment, an example in which a web browser in the MFP 101 as the information processing apparatus acquires screen information from the web server 102 and displays various user interfaces on an operation unit will be described. Furthermore, an example in which acquisition destination information used by the information processing apparatus to acquire screen information is a URL will be described. Furthermore, screen information is content generated, for example, in HyperText Markup Language (HTML) format.

Further, the web server 102 is capable of notifying a log type indicating login or logoff as log information to the MFP 101.

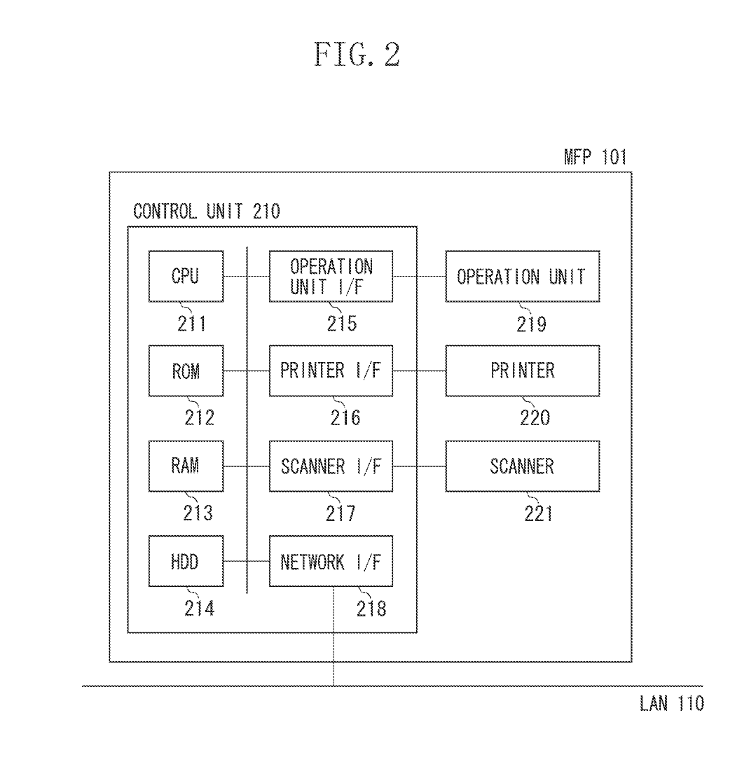

FIG. 2 is a block diagram illustrating a configuration of the MFP 101 illustrated in FIG. 1.

In FIG. 2, a control unit 210 including a central processing unit (CPU) 211 controls an operation of the MFP 101. The CPU 211 reads a control program stored in a read-only memory (ROM) 212 and executes various types of control processing, such as reading control and transmission control.

A random access memory (RAM) 213 is used as a main memory for the CPU 101 and a temporary storage area such as a work area. A hard disk drive (HDD) (a recording unit) 214 stores image data, various programs, or various information tables.

An operation unit interface (I/F) 215 connects an operation unit 219 and the control unit 210. The operation unit 219 includes a liquid crystal display unit having a touch panel function and a keyboard. The MFP 101 includes a web browser function described below. The web browser in the MFP 101 analyzes an HTML file received from the web server 102 and displays an operation screen based on the received HTML file on the operation unit 219. The operation unit 219 will be described in detail below.

A printer I/F 216 connects a printer 220 and the control unit 210. Image data to be printed by the printer 220 is transferred from the control unit 210 to the printer 220 via the printer I/F 216, and printed on a recording medium by the printer 220.

A scanner I/F 217 connects a scanner 221 and the control unit 210. The scanner 221 reads an image on a document, generates image data, and inputs the read image data to the control unit 210 via the scanner I/F 217.

A network I/F 218 connects the control unit 210 to a local area network (LAN) 110. The network I/F 218 transmits image data or information to an external apparatus (e.g., the web server 102) on the LAN 110, and receives various information from the external apparatus on the LAN 110.

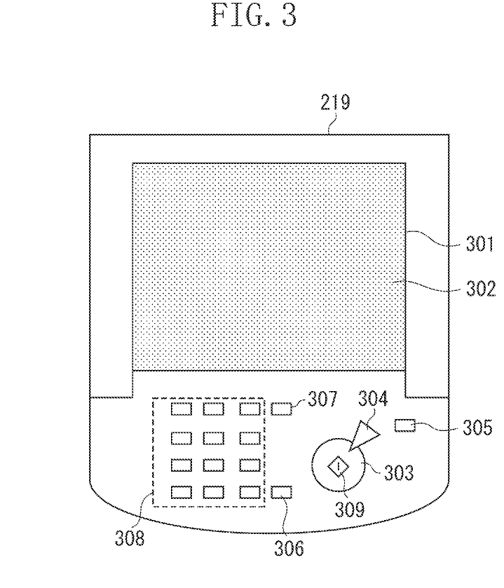

FIG. 3 illustrates an outer appearance configuration of the operation unit 219 illustrated in FIG. 2.

In FIG. 3, the operation unit 219 has a liquid crystal display (LCD) display unit 301 in which a touch panel sheet 302 is attached to an LCD. On the LCD display unit 301, an operation screen and a soft key which are displayed by a web browser are displayed. When a user pushes the displayed key, position information indicating the pushed position is transferred to the CPU 211. The operation screen displayed by the browser is generated from content generated by the web server 102, for example, in HTML format.

Further, the operation unit 219 includes various hard keys, such as a start key 303, a stop key 304, a reset key 305, a guide key 306, a top menu key 307, and a numeric keypad 308. At a center part of the start key 303, a light emitting diode (LED) display unit 309 with two colors of green and red is provided. These hardware keys will not be described in detail.

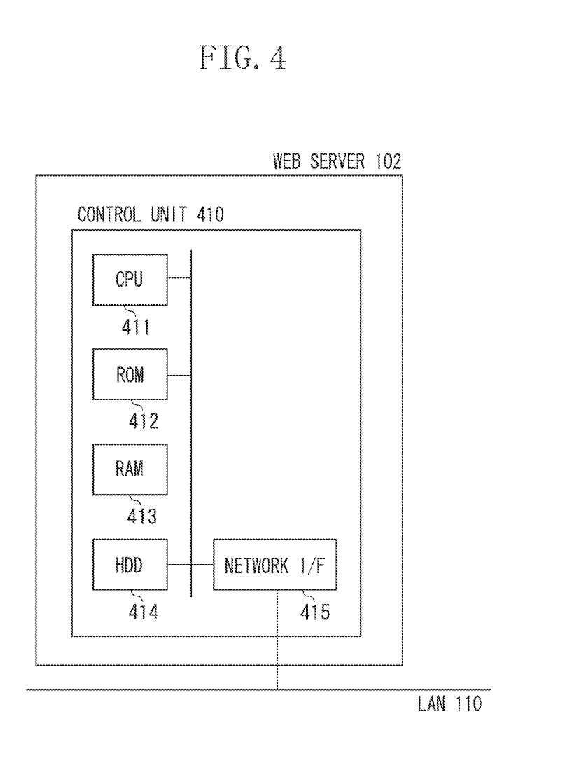

FIG. 4 is a block diagram illustrating a configuration of the web server 102 illustrated in FIG. 1.

In FIG. 4, a control unit 410 including a CPU 411 controls an operation of the entirety of the web server 102. The CPU 411 reads a control program stored in a ROM 412 and executes various control processing. A RAM 413 is used as a main memory for the CPU 411 or a temporary storage area such as a work area. An HDD 414 stores image data, various programs, or various information tables.

A network I/F 415 connects the control unit 410 (the web server 102) to the LAN 110. The network I/F 415 transmits/receives various information between the control unit 410 and other apparatuses on the LAN 110.

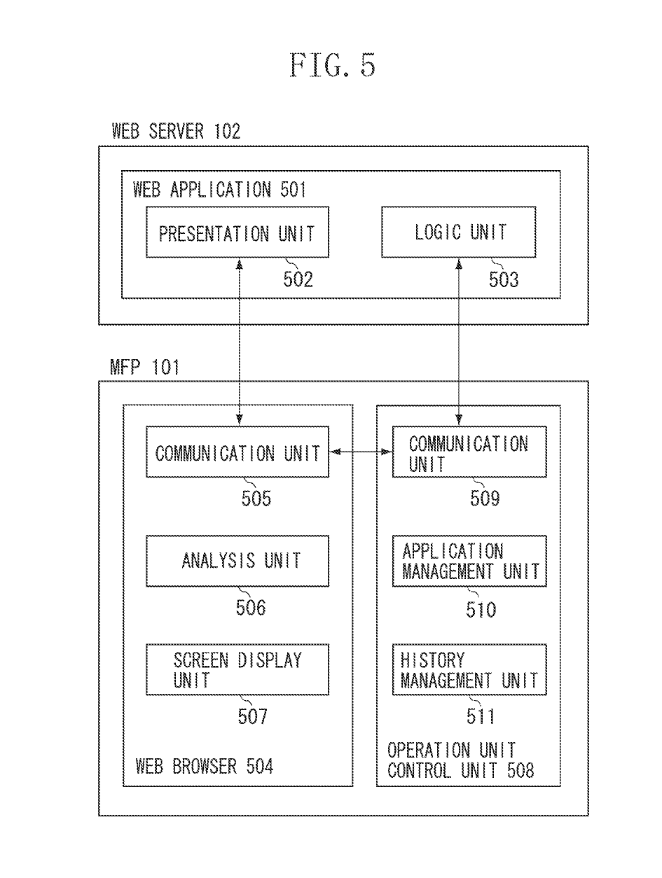

FIG. 5 illustrates a software configuration of the information processing system illustrated in FIG. 1. The software configurations of the web server 102 and the MFP 101 which constitute the information processing system illustrated in FIG. 1 will be described below.

In addition, the CPU 211 and the CPU 411 each included in the MFP 101 and the web server 102 execute a control program and realize each function unit configuring software illustrated in FIG. 5.

In FIG. 5, the MFP 101 includes a web browser 504 and an operation unit control unit 508. The web browser 504 includes a communication unit 505, an analysis unit 506, and a screen display unit 507.

The communication unit 505 communicates with a presentation unit 502 in a web application 501 according to a Hyper Text Transfer Protocol (HTTP) protocol. More specifically, the communication unit 505 requests an operation screen displayed on the web browser 504 to the web application 501, or notifies an instruction from a user input via the operation screen displayed on the web browser 504 to the web application 501.

Further, the communication unit 505 communicates with a communication unit 509 included in the operation unit control unit 508, and performs a notification about login or logoff to the web server 102, to the application management unit 510.

The analysis unit 506 records, as a history, a URL designated when the communication unit 504 requests an HTML file to the web application 501, and analyzes the HTML file received from the web application 501. The HTML file contains a description indicating content of the operation screen to be displayed on the web browser 504. Simultaneously, the analysis unit 506 receives an instruction about a method of history recording of a URL from a history management unit 511.

The screen display unit 507 displays, on the operation unit 219, an operation screen, particularly, a URL character string designating information (a HTML file) received from the web application 501, based on the analyzed result by the analysis unit 506.

The operation unit control unit 508 includes the communication unit 509, the application management unit 510, and the history management unit 511.

The communication unit 509 performs a processing request to the communication unit 505 in the web browser 504, or receives a processing request from the logic unit 503 included in the web application 501. The application management unit 510 receives information about login or logoff to the web server 102, directly from the logic unit 503 via the communication unit 509, or from the logic unit 503 via the communication unit 505 and the presentation unit 502.

The history management unit 511 requests processing about a method of history recording of a URL to the analysis unit 506 via the communication units 505 and 509, based on an instruction from the application management unit 510.

The web server 102 includes the web application 501.

The web application 501 includes the presentation unit 502 and the logic unit 503. The CPU 411 included in the web server 102 executes a control program, so that the web application 501, the presentation unit 502, and the logic unit 503 are executed respectively.

The presentation unit 502 communicates with the communication unit 505, receives a request transmitted from the MFP 101, notifies the received request to the logic unit 503, and waits a response from the logic unit 503. After receiving a response from the logic unit 503, the presentation unit 502 transmits, as a response, HTML data and information about login and logoff to the web server 102, which is control information, to the web browser 504. The HTML data corresponds to an operation screen to be displayed on the web browser 504 in the MFP 101.

The logic unit 503 executes various processing according to the request notified from the presentation unit 502, and generates an HTML file of screen information to be displayed in the MFP 101. Simultaneously, the logic unit 503 generates control information for controlling processing executed in the MFP 101.

More specifically, the control information is information about login or logoff to the web server 102. When the logic unit 503 requests the MFP 101 to execute processing, the logic unit 503 transfers the generated HTML file to the presentation unit 502, and transfers the generated control information to the presentation unit 502 or the communication unit 509.

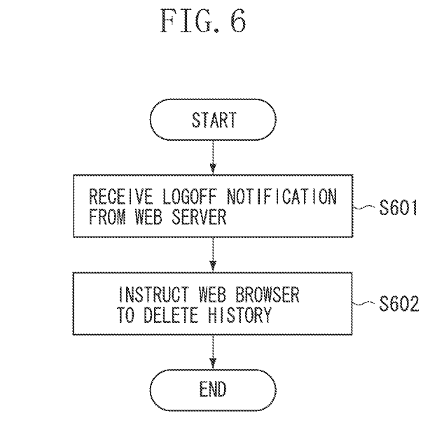

Processing in which the MFP 101 deletes an operation history in synchronization with a logoff notification will be described below with reference to FIGS. 6, 7A to 7D, and 8. Here, the MFP 101 is an example of an information processing apparatus according to an exemplary embodiment of the present invention.

FIG. 6 is a flowchart illustrating an example of a control procedure by the information processing apparatus according to the present exemplary embodiment. The present exemplary embodiment is a processing example to delete a URL history executed in the MFP 101. The CPU 211 in the MFP 101 loads a control program from the ROM 212 and the HDD 214 to the RAM 213 and executes the control program so that each step of the flowchart can be realized.

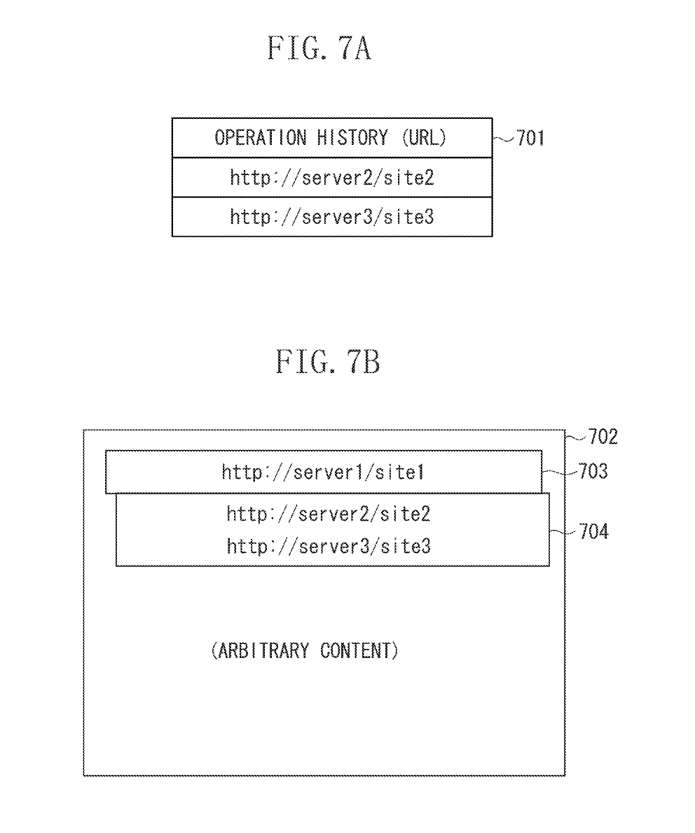

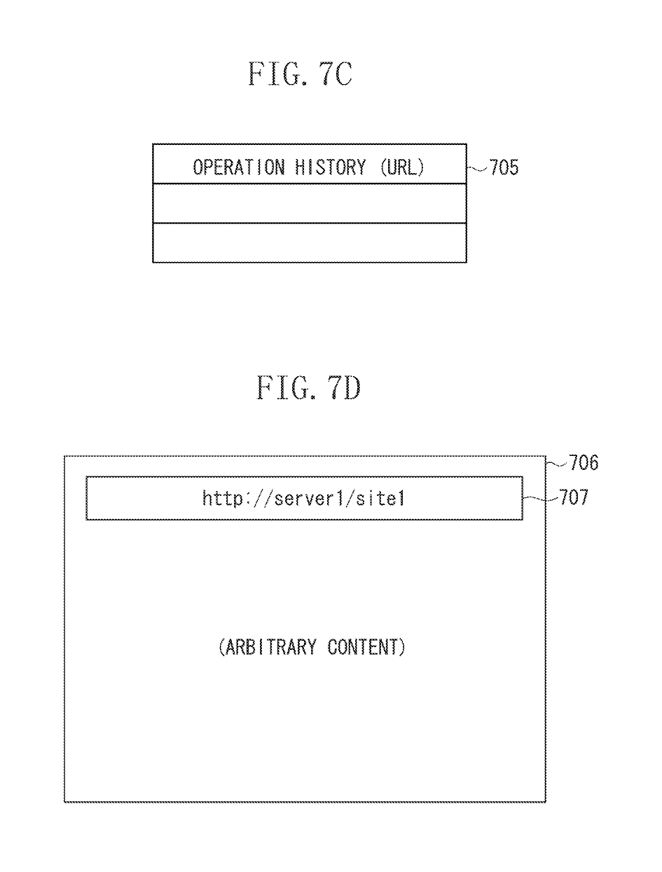

FIGS. 7A to 7D illustrate an example of a table managed by the analysis unit 506 illustrated in FIG. 5.

FIG. 7A is an example of a table of a URL history recorded in the HDD 214 by the analysis unit 506, and the example has particular history information.

FIG. 7B is an example of a display about a URL history displayed on the screen display unit 507, in which a table of the URL history recorded in the HDD 214 by the analysis unit 506 corresponds to a state illustrated in FIG. 7A.

FIG. 7C is an example of a table of a URL history recorded in the HDD 214 by the analysis unit 506, and there is no particular history in the example. FIG. 7D is an example of a display about a URL history displayed on the screen display unit 507, in which a table of the URL history recorded in the HDD 214 by the analysis unit 506 corresponds to a state illustrated in FIG. 7C.

When the processing starts, login to the web server 102 by an arbitrary user name is completed. Further, the web browser 504 performs a response request to the web application 501, and at this time, the analysis unit 506 records a URL as a request destination.

In step S601, when the communication unit 509 in the MFP 101 receives, from the web server 102, a logoff notification indicating that logoff processing by a user has been performed in the web server 102, and confirms the notification, the communication unit 509 records the notification in the HDD 214 via the application management unit 510. The format of the logoff notification can be any format.

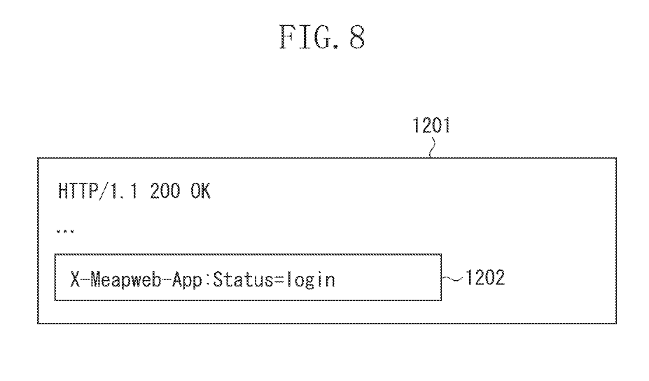

The logoff notification can be control information included in a response received from the presentation unit 502 included in the web server 102, or can be a direct notification from the logic unit 503 included in the web server 102. FIG. 8 illustrates an example of control information contained in the response received from the presentation unit 502.

In FIG. 8, an example 1201 is in HTTP header format, and a part 1202 of the content indicates a logoff notification.

In step S602, the analysis unit 506 deletes the recorded URL history according to a deletion instruction from the history management unit 511 on the condition that the communication unit 509 has received the logoff notification in step S601. Then, the processing ends.

In this procedure, FIG. 7A illustrates the URL history recorded in the HDD 214 by the analysis unit 506, for example, immediately after executing step S601. FIG. 7B illustrates a display about the URL history displayed on the screen display unit 507 based on the URL history illustrated in FIG. 7A.

FIG. 7C illustrates the URL history recorded in the HDD 214 by the analysis unit 506 immediately after executing step S602. FIG. 7D illustrates a display about the URL history displayed on the screen display unit 507 based on the URL history.

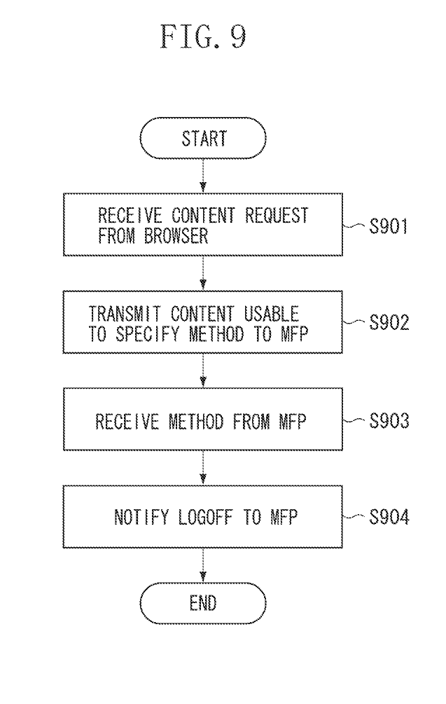

FIG. 9 is a flowchart illustrating an example of a data processing procedure by a server apparatus according to the present exemplary embodiment. The example is a processing example to delete the URL history executed in the web server 102 illustrated in FIG. 1. In addition, the CPU 411 included in the web server 102 loads and executes a control program (containing the presentation unit 502 illustrated in FIG. 5) in the RAM 413, so that each step of the flowchart can be realized.

In step S901, the presentation unit 502 receives a content request from the web browser 504 in the MFP 101 via a network. In this case, the content is information configuring an operation screen to be displayed on the operation unit 219 of the MFP 101.

In step S902, the presentation unit 502 transmits a method, such as logoff to the web server 102, to the MFP 101 as an HTML file (content) usable to input by a user instruction to the web browser 504.

In step S903, the presentation unit 502 receives the method in which information is input by the user instruction of the MFP 101. In step S904, the presentation unit 502 or the logic unit 503 notifies the method, more specifically logoff, to the MFP 101, and the processing ends.

With this processing, when the web browser 504 acquires information about logoff from the web server 102, the information of the URL used for requesting an operation screen is automatically deleted, so that a URL history of a previously logged-in user can be prevented from remaining.

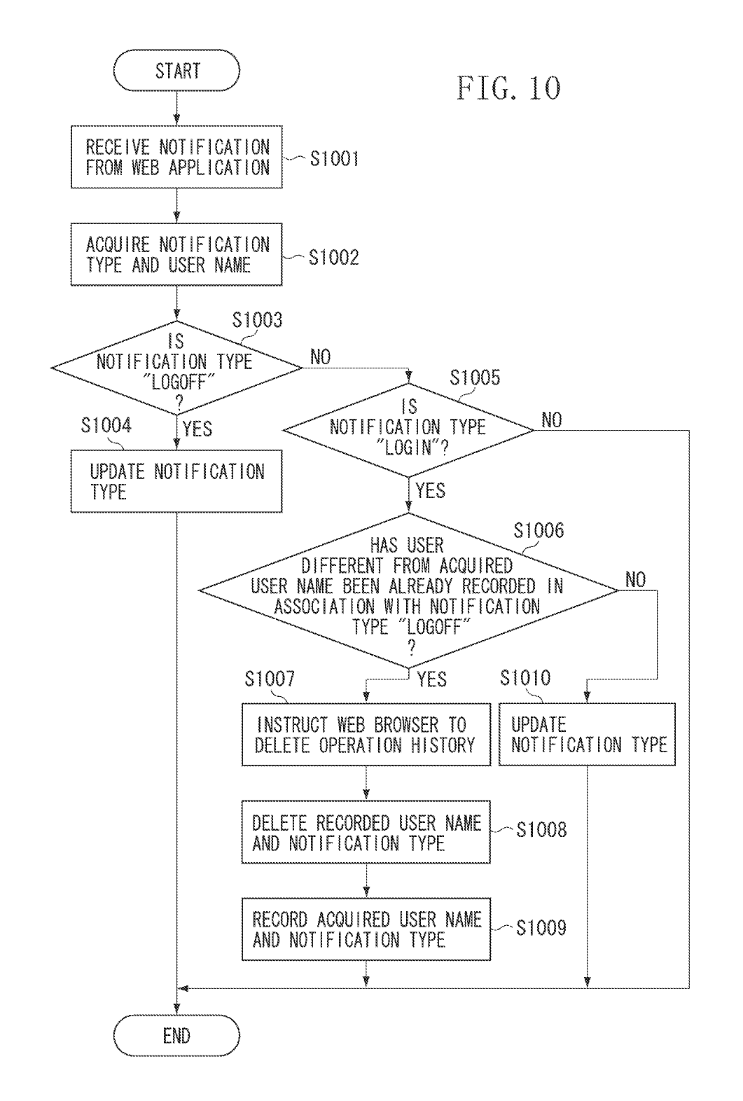

A second exemplary embodiment will be described below with reference to FIGS. 10, 11A, 11B, and 12. The second exemplary embodiment is configured to delete a URL history while considering user information contained in information about login of the web server 102. The information about login is notified from the web server 102.

FIG. 10 is a flowchart illustrating an example of a control procedure by an information processing apparatus according to the second exemplary embodiment of the present invention. The present exemplary embodiment is a processing example to delete a URL history executed in the MFP 101. The CPU 211 in the MFP 101 loads a control program from the ROM 212 and the HDD 214 to RAM 213 and executes the control program so that each step of the flowchart can be realized.

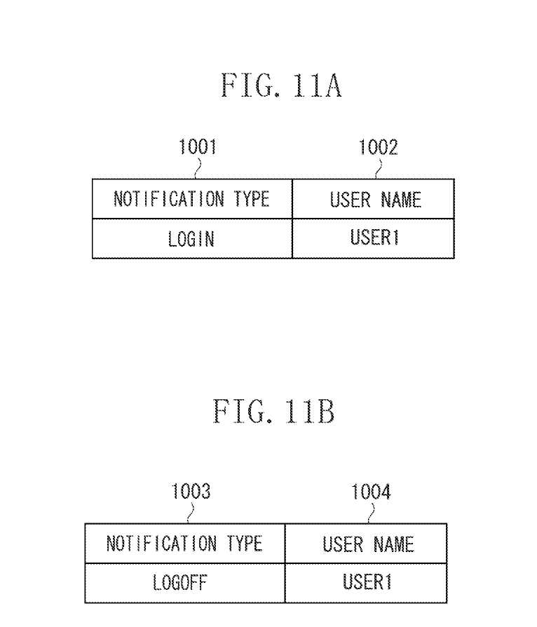

FIGS. 11A and 11B illustrate an example of a table held by the application management unit 510 illustrated in FIG. 5.

In addition, FIG. 11A illustrates a table held in the HDD 214 by the application management unit 510 and used to manage whether the web server 102 is in a state immediately after login or logoff by which user. The table illustrated in FIG. 11A indicates that a user “User1” (user 1002) is in a login state 1001. FIG. 11B is similar to FIG. 11A and indicates that a user “User1” (user 1004) is in a logoff state 1003.

When the processing starts, the web browser 504 performs a response request to the web application 501 and, at this time, the analysis unit 506 records a URL as a request destination. In addition, a recording destination of the URL contains a case in which the destination is the RAM 213 included in the MFP 101 and a case in which the destination is the HDD 214.

In step S1001, the communication unit 509 in the MFP 101 receives, from the web application 501, a notification about whether which user logs in or logs off the web server 102. The format of the notification can be any format. The notification can be control information contained in a response received from the presentation unit 502 included in the web server 102, or can be a direct notification from the logic unit 503 included in the web server 102.

An example of control information contained in a response received from the presentation unit 502 in the web server 102 is similar to the example in FIG. 8. However, the control information contains a user name in addition to the information 1202 indicating a logoff notification.

For example, when the user name is “User1”, the control information has a format of “X-Meapweb-App:Status=login, user=User1.”

In step S1002, the application management unit 510 acquires a type of information notified from the information received from the logic unit 503 in step S1001, i.e., “login” or “logoff”, and the user name.

In step S1003, the application management unit 510 determines whether the notification type is “log off”. When the application management unit 510 determines that the notification type is “logoff” (YES in step S1003), the processing proceeds to step S1004.

In step S1004, the application management unit 510 updates the notification type to be “logoff”. The processing in step S1004 is performed under the premise that the same user name as the user name acquired in step S1002 is recorded with the notification type of “login” in the table held in the HDD 214 by the application management unit 510.

For example, when the acquired user name is “User1”, the table illustrated in FIG. 11A is a premise, and the table immediately after in Step S1004 is illustrated in FIG. 11B.

On the other hand, when the application management unit 510 determines that the notification type is not “logoff” in step S1003 (NO in step S1003), the processing proceeds to step S1005.

In step S1005, the application management unit 510 determines whether the notification type of the information received from the logic unit 503 is “login”. When the application management unit 510 determines that the notification type is “login” (YES in step S1005), the processing proceeds to step S1006.

In step S1006, the application management unit 510 determines whether a user having a different user name from the user name acquired in step S1002 has been recorded in association with the notification type “logoff”. When the application management unit 510 determines that the user having a different user name has been recorded in association with the notification type “logoff” (YES instep S1006), the processing proceeds to step S1007.

In addition, in step S1006, when a table immediately before the determination is performed is FIG. 11B and the acquired user name is “User2” (different from the User1), the application management unit 510 determines that the user having a different user name is recorded in association with the notification type “logoff.”

In step S1007, the history management unit 511 instructs the analysis unit 506 to delete the URL history recorded in the HDD 214 by the analysis unit 506. As a result, the URL history recorded in the analysis unit 506 is deleted.

With this processing, when the processing proceeds from step S1003 to step S1004, the processing to delete the URL history is not executed. This is in order to deal with a request by a user who desires to use the history when the user logs in immediately after the user logged off.

In step S1007, the history is deleted for the first time because the application management unit 510 can determine that the different user has logged in previous steps S1005 and S1006.

In step S1008, the application management unit 510 deletes the recorded user name and notification type. In step S1009, the application management unit 510 records the user name and the notification type which are acquired in step S1002. Then, the processing ends.

On the other hand, in step S1006, when the application management unit 510 determines that the same user name as the acquired user name is recorded with the notification type “logoff” (NO in step S1006), the processing proceeds to step S1010. In steps S1010, the application management unit 510 updates the notification type, and the processing ends.

In step S1005, when the application management unit 510 determines that the notification type is not “login” (NO in step S1005), the processing ends.

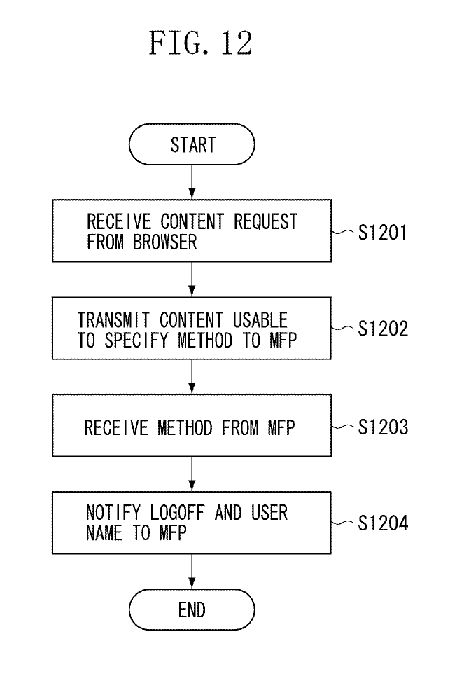

FIG. 12 is a flowchart illustrating an example of a data processing procedure in a server apparatus according to the present exemplary embodiment. The example is a processing example to delete a URL history executed in the web server 102. The example is the processing example to delete the URL history executed in the web server 102 illustrated in FIG. 1. In addition, the CPU 411 included in the web server 102 loads and executes a control program (containing the presentation unit 502 illustrated in FIG. 5) in the RAM 413, so that each step of the flowchart can be realized.

In step S1201, the presentation unit 502 receives a request from the web browser 504 in the MFP 101 via a network. In step S1202, the presentation unit 502 transmits a method, such as logoff, to the web server 102, and an HTML file (content) usable to input by a user instruction to the web browser 504, to the MFP 101.

In step S1203, the presentation unit 502 receives the method input by a user instruction. In step S1204, the presentation unit 502 or the logic unit 503 notifies, to the MFP 101, a method, i.e., more specifically, logoff, and the user name about the logoff simultaneously. Then, the processing ends.

With this processing, when another user logs in instead of a user who logged in previously using the MFP 101, the information of the URL from which the content of the operation screen is acquired can be prevented from being recorded and becoming usable by another user.

Further, in a process in which an unspecified user operates a constantly-displayed browser included in an information processing apparatus, the unspecified user can be prevented from viewing a URL based on a history of a user other than the unspecified user, so that both operability and security can be improved.

Aspects of the present invention can also be realized by a computer of a system or apparatus (or devices such as a CPU or MPU) that reads out and executes a program recorded on a memory device, such as a computer-readable storage medium, to perform the functions of the above-described embodiment(s), and by a method, the steps of which are performed by a computer of a system or apparatus by, for example, reading out and executing a program recorded on a memory device, such as a computer-readable storage medium, to perform the functions of the above-described embodiment(s). For this purpose, the program is provided to the computer for example via a network or from a computer-readable storage medium of various types serving as the memory device.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-178305 filed Aug. 9, 2010, which is hereby incorporated by reference herein in its entirety.

What is claimed is:

1. An information processing apparatus configured to display a screen using information acquired from a server apparatus, the information processing apparatus comprising:
a recording unit configured to record acquisition destination information for acquiring the information from the server apparatus;
a receiving unit configured to receive, from the sever apparatus, a logoff notification indicating that a user has logged off the server apparatus; and
a deletion unit configured to delete the recorded acquisition destination information in response to receipt of the logoff notification by the receiving unit.

2. The information processing apparatus according to claim 1, wherein the acquisition destination information is a Uniform Resource Locator (URL) for acquiring the information from the server apparatus.

3. An information processing apparatus configured to display a screen using information acquired from a server apparatus, the information processing apparatus comprising:
a recording unit configured to record history information including log information indicating login or logoff notified from the server apparatus, user information, and acquisition destination information for acquiring the information from the server apparatus, wherein the log information, the user information, and the acquisition destination information are associated with each other;
a determination unit configured to, when the log information notified from the server apparatus is login, determine whether user information associated with a present login operation is the same as user information which was used for a login operation performed immediately prior to the present login operation by referring to the history information; and
a deletion unit configured to update the log information in the history information when the determination unit determines that the user information for the present login operation is the same as the user information for the login operation performed immediately prior to the present login operation, and to delete the recorded history information when the determination unit determines that the user information for the present login operation is different than the user information for the login operation performed immediately prior to the present login operation.

4. The information processing apparatus according to claim 3, wherein the acquisition destination information is a Uniform Resource Locator (URL) for acquiring the information from the server apparatus.

5. A method for controlling an information processing apparatus configured to display a screen using information acquired from a server apparatus, the method comprising:
recording acquisition destination information for acquiring the information from the server apparatus;
receiving a logoff notification indicating that a user has logged off the server apparatus; and
deleting the recorded acquisition destination information in response to the received logoff notification.

6. A computer-readable storage medium storing a program for causing a computer to execute the method according to claim 5.

7. A method for controlling an information processing apparatus configured to display a screen using information acquired from a server apparatus, the method comprising:
recording history information including log information indicating login or logoff notified from the server apparatus, user information, and acquisition destination information for acquiring the information from the server apparatus, wherein the log information, the user information, and the acquisition destination information are associated with each other;
determining, when the log information notified from the server apparatus is login, whether user information associated with a present login operation is the same as user information which was used for a login operation performed immediately prior to the present login operation by referring to the history information; and
updating the log information in the history information when it is determined that the user information for the present login operation is the same as the user information for the login operation performed immediately before the present login operation, and deleting the recorded history information when it is determined that the user information for the present login operation is different than the user information for the login operation performed immediately before the present login operation.

8. A computer-readable storage medium storing a program for causing a computer to execute the method according to claim 7.
